(19) United States
(12) Patent Application Publication
(10) Pub. No.: US 2008/0217254 A1
(43) Pub. Date: Sep. 11, 2008

(54) Magnetic Bead Trap and Mass Spectrometer Interface

(76) Inventor: N. Leigh Anderson, Washington, DC (US)

Correspondence Address: COOLEY GODWARD KRONISH LLP;ATTN: Patent Group, Suite 1100, 777 - 6th Street, NW, WASHINGTON, DC, 20001, US

(21) Appl. No.: 12/042,931

(22) Filed: Mar. 5, 2008

Related U.S. Application Data
(60) Provisional application No. 60/904,922, filed on Mar. 5, 2007.
(60) Provisional application No. 60/955,195, filed on Aug. 10, 2007.

(51) Int. Cl. B03C 1/00; B01J 19/08; B01D 59/44

(52) U.S. Cl. 210/695; 204/660; 250/282

(57) ABSTRACT

A device and method for capture of magnetic beads in a rotary magnetic bead trap is disclosed. The device allows capture, washing, elution and ejection of beads in an automated system. Analyte is eluted in a small volume in a capillary-scale fluid system compatible with LC-MS/MS analysis.

### CROSS-REFERENCE TO RELATED APPLICATIONS

This application claims priority to U.S. Provisional Patent Application 60/904,922 filed Mar. 5, 2007 and U.S. Provisional Patent Application 60/955,195 filed Aug. 10, 2007, both of which are incorporated herein by reference in their entirety.

### BACKGROUND

Many techniques of molecular analysis involve specific capture or enrichment of one or more target molecules as a means of improving specificity or sensitivity of the analysis. When a target analyte is present at low concentration, and a successful method is available for enriching it to the level of detection, it is important that the enriched material be delivered for analysis with minimal subsequent contamination or dilution if the benefit of the enrichment is to be realized. When very small amounts of analytes are involved, this presents a major challenge, since small amounts of many substances can be bound by (and therefore lost upon) the surfaces of storage vessels, transporting devices, connecting tubing, etc. Ideally, a method of enrichment would include the means for delivering the concentrated analyte directly to the analytical system without any interposed storage vessels or tubing.

For example, when peptides are captured by immobilized binding agents (typically anti-peptide antibodies) as part of the SISCAPA technique (Anderson, Anderson, Haines, Hardie, Olafson and Pearson, J Proteome Res 3:235-44, 2004, which is herein incorporated by reference in its entirety), it is important to transfer these peptides to the next step of the analysis (generally liquid chromatography (LC) prior to tandem mass spectrometry (MS/MS)) as efficiently as possible. Losses in this process impair ultimate analytical sensitivity, and it is important that any dilution occurring during the recovery of the peptides from the immobilized binding agents be kept to an absolute minimum.

Binding agents that are immobilized on beads or particles that can be manipulated in free solution, e.g., by a magnetic field in the case of paramagnetic beads, represent a particularly attractive approach for analyte enrichment. Numerous companies (Dynal, Pierce Chemical, Qiagen, etc.) supply magnetic beads with surface coatings that facilitate covalent or non-covalent binding of high-specificity capture reagents such as antibodies. Use of binding agents on magnetic beads facilitates parallel processing of multiple samples, e.g., 96 aliquots of a bead preparation applied to 96 different tryptic digests of biological samples in a 96-well plate, and also allows multiple different binding agents to be exposed to one or more samples, e.g., 10 different binding agents (or groups of binding agents) on 10 different beads preparations, each serially exposed to a single digest sample and removed from it. Many steps in the process of making, washing and incubating such coated magnetic beads can be automated with existing equipment such as the ThermoFisher Corp. “Kingfisher” device.

However elution of bound peptides by the typical means into a conventional tube or well (e.g., of a multiwell plate) results in substantial dilution of the peptide (practical elution volumes in a well range from 10 to 30 ul, almost 100 times the volume of the beads themselves). LC-MS/MS autosamplers used in the most sensitive nanoflow chromatography systems typically cannot access the last small volume of sample in such vessels, leading to wasted sample peptides. In addition, exposure of low-abundance peptides to the large wall surface area of multiwell plate wells and sample vials often results in substantial adsorptive losses, and hence reduced analytical precision and sensitivity. It is frequently observed that very low abundance peptides are entirely lost by such adsorption mechanisms. These concerns lead to a need to handle magnetic beads and their adsorbed analytes in such a way that the analytes can be eluted directly into the flow path of a suitable, generally capillary-scale, tubing system capable of delivering them undiluted and without losses into an LC-MS/MS system. Once analytes are in this flow path, they cannot be lost before analysis except by adsorption to the flow path walls, and to prevent this, it can be arranged that this flow path is washed with solvents that completely mobilize the analyte. The principle requirements in a workable device to implement this approach are: 1) the need to retain beads in a ‘trap’ region against the flow of liquid (loading, wash and elution buffers, for example) in a vessel of capillary dimensions; 2) the need to ensure that no beads escape from the trap region to contaminate downstream apparatus or columns; 3) the need to ensure that beads are effectively mixed with the flowing fluids (required for efficient washing and elution); and 4) the need to ensure that all beads can be efficiently ejected from the trap region in preparation for the next cycle. Ideally these needs would be met by an economical mechanical device, which I refer to as a “bead trap”.

There is an extensive literature on macroscopic and microfluidic devices for manipulating magnetic beads (reviewed in Safarik and Safarikova, Biomagn Res Technol 2:7, 2004; Pamme, Lab Chip 6:24-38, 2006; and Gijs, Microfluid Nanofluid 1:22-40, 2004), on the mixing of small fluid volumes by causing movement of suspended magnetic beads in response to a variable or moving magnetic field (Biswal and Gast, Anal Chem 76:6448-55, 2004; Suzuki, Ho and Kasagi, J Micromechanical Systems 13:779-90, 2004; Rida and Gijs, Anal Chem 76:6239-46, 2004; Herrmann, Veres and Tabrizian, Lab Chip 6:555-60, 2006; Kamada U.S. Pat. No. 4,916,081; Sugarman U.S. Pat. No. 5,222,808), on the collection of beads in a static magnetic trap as part of an assay (Smistrup, Kjeldsen, Reimers, Dufva, Petersen and Hansen, Lab Chip 5:1315-9, 2005; Dubus, Gravel, LeDrogoff, Nobert, Veres and Boudreau, Anal. Chem. 78:4457-4464, 2006; Choi, Oh, Thomas, Heineman, Halsall, Nevin, Helmicki, Henderson and Ahn, Lab Chip 2:27-30, 2002; Fan, Mangru, Granzow, Heaney, Ho, Dong and Kumar, Anal Chem 71:4851-9, 1999; Hayes, Polson, Phayre and Garcia, Anal Chem 73:5896-902, 2001; Rida US patent application 2005/0208464; Chen U.S. Pat. No. 6,132,607; Otillar US patent application 2003/0012693), on the transport of beads along a flow path (Fernandez US patent application 2005/0284817; Franzreb US patent application 2007/0144976), and on the use of field-induced movement to process beads through a series of liquids (Ostergaard, Blankenstein, Dirac and Leistiko, Journal of Magnetism and Magnetic Materials 194:156-162, 1999; Forrest U.S. Pat. No. 4,141,687).

The prior art does not, however, provide a device fulfilling the present requirements. The disclosed invention does so, enabling processing of analytes on magnetic beads completely within the flow path of a capillary LC system.

### SUMMARY OF THE INVENTION

The present invention provides an apparatus and method for the trapping of magnetic beads carrying bound analytes in a length of a narrow channel, active prevention of loss of beads into the liquid stream flowing in this channel, efficient washing of the trapped beads by the flowing liquid, efficient elution of the analytes into a small volume of fluid eluent, efficient transport of analytes to the subsequent analytical stage and final positive ejection of the beads out of the channel. In this approach the device (the magnetic “bead trap”) is generally installed across a switchable fluid path so as to allow a bead suspension to be injected into the trap, different solvents to flow over the beads in the trap (while the outlet is selectably connected to waste or to an LC-MS/MS of MS system), and finally to allow the beads to be ejected, either to waste or to a vessel for re-use. Various strategies can be employed to transport the beads to the trap, in some of which the sample (from which the beads bind the analyte(s)) is preserved for later retesting or detection of other analytes. The invention provides for multiple sequential magnetic trapping zones capable of sweeping beads against liquid flow to prevent escape of beads through the trapping device (i.e. the second downstream trapping zone capturing beads that escape the first trap under the influence of liquid flow, and so on), means for moving these trapping regions so as to agitate the trapped bead mass and mix it with fluids flowing past, and means for reversing the sweeping action to effectively eject beads from the trap into the fluid stream.

The invention is conceived in such a way as to allow it to be implemented through addition of an economical electromechanical device to existing liquid handling systems, particularly those used for liquid chromatography and mass spectrometry. It provides a general interface between any affinity capture process implemented on magnetic beads and an LC, LC-MS/MS or MS analytical system. In a particularly effective embodiment, a reversibly rotatable rotor carrying a multiplicity of permanent magnet assemblies is used to either trap beads in a series of sequential traps (while mixing them with passing liquid flow) or eject beads by changing the direction of rotation.

Analytes released by elution from magnetic beads in the trap can be introduced directly into a mass spectrometer, or else further resolved or otherwise manipulated in a chromatographic flow system. In the former case, the analytes can be eluted from the beads in a solvent appropriate for an MS sample (e.g., 50% acetonitrile with 0.1% formic acid for direct infusion into an electrospray MS source, or else a solution of MALDI matrix material deposited on a MALDI-MS target). For additional separation, the eluent can be introduced for example onto a C18 reversed phase analytical column, or onto a reversed phase trap for later introduction onto such an analytical column.

The invention makes possible the rapid introduction of analytes on magnetic bead capture supports into capillary and other flow systems, and thus allows high-throughput processing of such samples on expensive MS instrumentation. The invention provides a general approach to handling analytes that minimizes losses on surfaces encountered between the initial capture step and final delivery into an analytical system.

### BRIEF DESCRIPTION OF THE DRAWINGS

FIG. 1A-D. Diagram of a rotary bead trap capable of sweeping beads against (FIG. 1A) or with (FIG. 1B) the direction of fluid flow. FIG. 1C shows a magnified view of a parcel of beads located in a trapping region, and FIG. 1D provides a side view of the apparatus.

FIG. 2A-C. Diagram of a rotary bead trap with a reservoir zone in which beads can be parked out of the main flow path.

FIG. 3. Plumbing diagram of a liquid chromatography-mass spectrometry system including a magnetic bead trap. In this figure the two switchable valves are set to the positions they assume in the first step of four-step process.

FIG. 4. Schematic diagram of an embodiment including a magnetic bead trap situated to capture and process magnetic beads prior to passage through any switchable valves.

FIG. 5. Elution profile of fluorescently labeled peptide from magnetic beads in a bead trap.

FIG. 6. Schematic plumbing diagram of an LC-MS/MS system incorporating a magnetic bead trap as used in Example 1.

FIG. 7. LC-MS/MS results (MRM) showing enrichment of a specific target peptide on antibody coated magnetic beads (SISCAPA capture) that were washed and eluted in a magnetic bead trap as disclosed.

### DETAILED DESCRIPTION OF THE INVENTION

This invention provides a fluid-handling device and method for transporting magnetic beads capable of binding desired analytes (including peptides and/or proteins, nucleic acids and small molecules), retaining beads without loss during exposure to fluid flows with good mixing, eluting bound analytes in a small volume, delivering the analytes into a capillary tubing system for molecular analysis, and positively ejecting the spent beads.

The invention is illustrated using the SISCAPA method for protein quantitation: in this method sample proteins are digested with an enzyme such as trypsin to yield peptides; one or more of these (typically a sequence unique to the protein in question) is captured from the digest by peptide-specific anti-peptide antibodies (as specific binding agents) and quantitated against an added internal standard by mass spectrometry. Other sets of binding agents can be used to similarly detect other classes of analyte molecules. Throughout the disclosure, the terms “analyte”, and “ligand” may be any of a variety of different molecules, or components, pieces, fragments or sections of different molecules that one desires to measure or quantitate in a sample, including peptides, proteins, nucleic acids, glycans and small molecules. Capture of drug molecules from blood serum or plasma by specific antibodies bound to magnetic particles would be a particularly useful additional application.

The terms “binding agent” and “receptor” may be any of a large number of different molecules, biological cells or aggregates, and the terms are used interchangeably. In this context, a binding agent functions by binding to an analyte in order to enrich it prior to detection. Proteins, polypeptides, peptides, nucleic acids (oligonucleotides and polynucleotides), antibodies, ligands, polysaccharides, microorganisms, receptors, antibiotics, and test compounds (particularly those produced by combinatorial chemistry) may each be a binding agent.

The term “antibody” may be any of the classes of immunoglobulin molecules of any species, or any molecules derived therefrom, or any other specific binding agents constructed by variation of a conserved molecular scaffold so as to specifically bind an analyte or signature fragment. The term “anti-peptide antibody” may be any type of antibody (in the preceding general sense) that binds a specific peptide, signature peptide, or other signature fragment for the purposes of enrichment from a sample or processed sample. In general, any use made of an antibody herein is understood to be a purpose that could also be served by a binding agent as defined above.

The term “bind” includes any physical attachment or close association, which may be permanent or temporary. Generally, reversible binding includes aspects of charge interactions, hydrogen bonding, hydrophobic forces, van der Waals forces, etc., that facilitate physical attachment between the molecule of interest and the analyte being measured. The “binding” interaction may be brief as in the situation where binding causes a chemical reaction to occur. Reactions resulting from contact between the binding agent and the analyte are also within the definition of binding for the purposes of the present invention, provided they can be later reversed to release a signature fragment.

The terms “magnetic bead” or “magnetic particle” mean any of a variety of particulate materials having the property, when suspended in a fluid, of moving under the influence of a magnetic field. A particularly useful type of magnetic particle incorporates paramagnetic material such that it is essentially non-magnetic in the absence of an external magnetic field, but acquires a strong induced magnetic character when placed in an external magnetic field. The term also includes diamagnetic particles. “Magnet” and “magnetic field generator” mean any object emitting a magnetic field, either permanently or intermittently (for example upon actuation by an electrical current in the case of an electromagnet).

The term “magnetic trapping region” (or zone) means a spatial region towards which and into which a magnetic particle is attracted. In the case of paramagnetic particles, the most relevant feature defining a magnetic trapping region is the local “magnetic field gradient”, such that the particles are attracted towards the highest field gradient.

The terms “channel”, “lumen” and “tube” refer to any walled fluid flow path capable of conducting a fluid stream from one location to another, and thus include tubing (typically of capillary dimensions) as well as channels in bulk materials or in planar substrates: references to a lumen in a member refers to all of these possibilities.

The term “mass spectrometer” means a device capable of detecting specific molecular species and measuring their masses. The term is meant to include any molecular detector into which a captured analyte molecule may be eluted for detection and/or characterization.

In each of the following embodiments and examples, it is to be assumed that the method of use can include either permanent magnets or electromagnets, that the magnets or the fluid lumen can be fixed or moving, and that the analytes can be any class of molecule or atom that binds to a magnetic particle.

### OBJECTS OF THE INVENTION

It is an object of the invention to improve the efficiency by which analyte molecules can be captured in solution, transported into an analytical system such as a liquid chromatograph or a mass spectrometer with minimal loss, and released for analysis. It is a further object of the invention to capture magnetic beads carrying analyte from a liquid stream and retain them against continued liquid flow, while allowing effective mixing of the beads with the flow, and finally to actively eject the beads into the liquid stream.

### EMBODIMENTS OF THE INVENTION

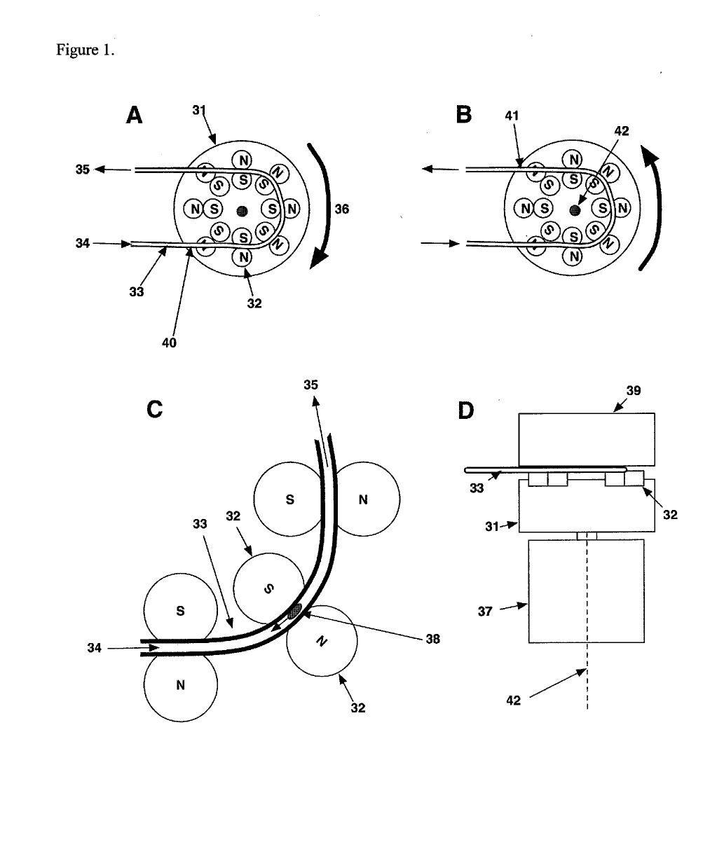

In a first embodiment, a series of magnets is arranged so as to provide a plurality of magnetic trapping regions (“traps”), and these traps can be moved with respect to a capillary tube in which the magnetic bead trapping and transport occur (as shown in FIG. 1). A rotary configuration is shown in which pairs of disk-shaped rare earth permanent magnets 32 (e.g., ¼″ dia× 3/16″ thick cylinders) interact to form the individual traps: when such cylinders, which are magnetized along the cylinder axis, are placed side-by-side with opposite orientations (e.g., magnets 32 in which one member of the pair has its North pole up and the other beside it has South up) a very strong magnetic field gradient is formed at the point of contact of the cylinder edges. This strong gradient region provides an excellent magnetic bead trap. Alternatively, two magnets having square cross-sections, placed side by side with antiparallel fields (i.e. with co-planar adjacent North and South faces), generate two very strong field gradient trapping regions at the two corners where the co-planar North and South faces touch. Other arrangements of permanent magnets can also generate high field gradients (and thus strong bead trapping regions), including arrangements in which local fields are created in a continuous plate of permanent magnet material.

By disposing a series of such magnet pairs (e.g., 8 pairs) around the circumference of a rotatable trap carrier (or rotor) 31 (seen in FIG. 1A from above, looking down the axis of rotation), the trap regions are moved in a circle by the carrier's rotation about its axis 42. When a suitable liquid channel 33 (in this case a capillary tube of ˜50-300 micron inner diameter, here the member defining a lumen) is bent to follow an arc comprising at least part of the circle along which the trap regions move when the carrier (or rotor) is rotated about its axis 42, and the tube is mounted in close proximity to (though not mechanically interfering with), and co-planar with, the faces of the magnets on the carrier, then magnetic trap regions (regions of high magnetic field gradient) will be formed within the tube and move along it, with a direction determined by the direction of rotation of the trap carrier. Suitable materials for the tubes include fused silica, Teflon, polyetheretherketone, and polyethylene.

As shown in FIG. 1D, the carrier 31 may be mounted directly on a reversible motor 37, and arranged immediately below a loop of tubing 33 affixed on the under surface of plate 39 which is brought close to the upper surface of the carrier and the magnets on the carrier. The rate of rotation can be variable to allow tuning of the bead motions, or fixed at an optimum value (near 2 rpm for a trap circle of 1-1.5″ diameter). The motion of the trap regions in this case is analogous to the motion of the pinches used to transport material down a flexible tube in a conventional peristaltic pump, except that here the force is magnetic. In FIG. 1A, the carrier rotates clockwise and thus the trap regions in tube 33 progress in a clockwise direction. By reversing the rotation of the carrier in FIG. 1B, the trap regions within the tube move in the opposite direction. FIG. 1C shows the effect of clockwise carrier rotation when fluid is being pumped through the tube (here showing one quadrant of the carrier and its superposed tubing loop), entering as flow 34 and exiting as flow 35: the fluid flow is in the opposite direction from the trap movement, and thus a collection of magnetic beads 38 captured in a trap region formed by magnets 32 are transported clockwise against the liquid current. The beads are thus always being swept “upstream”. In this embodiment the fluid control mechanism can be a syringe, a syringe pump, a piston pump or any of a variety of fluid flow sources.

At the point 40 where the tube diverges away from the circle of magnetic trapping regions, the susceptibility of the magnetic beads to the influence of the trapping regions rapidly diminishes. The magnetic fields of the magnet pairs used here is extremely localized: having a very strong maximum field at the points of contact between the members of a pair, the field strength and the magnitude of the field gradient decline rapidly with distance from the N:S pair contact point. In the case where fluid flow and magnetic trap region movement are opposite to one another as in FIG. 1A (i.e., when the bead trap is retaining the beads against fluid flow), the beads being magnetically transported along the tube ‘stall’ as the currently-adjacent magnetic trapping region rotates past (its attractive effect diminishing rapidly with distance) and the beads submit to the now-dominant influence of the liquid flow, in which they are transported back towards the circle of magnetic zones, to be picked up by the next passing trapping region as it rotates into position. When fluid flow and rotation are constant, beads are stably trapped in the device: the beads are always swept to a region in which they perform a reciprocating motion around position 40, repeatedly swept to the left by a passing magnetic zone, and then pushed back to the right by the flow of liquid in the tube. This stable oscillation provides extremely effective mixing of beads and flowing liquid, providing an important feature of the invention.

When magnet carrier rotation is counter-clockwise (FIG. 1B) the beads are transported counterclockwise by both magnetic force and fluid flow. When the beads reach the point 41 at which the influence of magnetic trap regions declines, they continue on under the influence of fluid flow alone and swept out of the trap system. The combined sweeping action of magnetic traps and fluid flow is very effective in positively displacing all beads from the trap channel.

A sensor and associated display readout can be configured as part of the bead trap to confirm the presence or amount of magnetic beads in the trap. Suitable sensors include magnetic field sensors (sensing the alteration in magnetic field caused by the beads and delivering a readout via computer analysis) and optical sensors (which can include television cameras imaging the beads trapped in the bead trap, with visual image displays as readout).

Three important advantages may be provided by this embodiment. First, since, in the trapping configuration, the beads are always being swept upstream against the fluid flow by movement of trap regions in the rotation direction, and since beads that slip out of one trap region will be gathered up by the following region coming around the circle, the probability of bead loss due to fluid movement down the tube is much reduced. Since the tube follows the circle of trap regions for an arc that encompasses two or more trap regions, there is always a second trap behind the first one that beads see when entering the system. This succession of traps is effective in preventing bead loss even when one or more bubbles move through the tube.

Second, the fact that stably-trapped beads are always moving in a reciprocating motion, in which they are dragged along the wall of the tube, means that they are constantly being stirred with respect to the liquid moving by, and thus the equilibration of the magnetically agglomerated bead clump with the liquid phase is much improved compared to a static magnetic trap (in which a poorly-perfused clump of beads adheres to the side of a channel). As the leading trap region moves away from the tube at the point 40 where the tube diverges from the circle, and its holding force declines, the beads are gradually released, to be swept by the fluid flow downstream into the following trap region. This periodic ‘stroking’ of bead clumps upstream (by trap movement) and then downstream (by fluid flow) provides improved mixing of beads with the flowing fluid.

Third, by reversing the direction of rotation of the trap carrier, the beads can be positively swept out of the tube and eliminated from the system. The control of rotation direction (easily controlled using an auxiliary logic output of an autosampler or liquid chromatograph under software control) thus provides a single means of controlling whether beads will be retained in the trap or ejected.

In the case of magnetic beads having a somewhat hydrophobic or otherwise sticky surface, performance of the system can be further improved by incorporation of mild detergents in the fluid stream during trap loading, washing and ejection. Concentrations of 0.1% to 1% of octylglucoside or CHAPS detergents effectively reduce binding of beads to walls of silica or Teflon capillary tubes.

Elution of bead-bound analytes can be obtained in a very small fluid volume (e.g., <1 ul) by halting liquid flow when the appropriate elution solvent is present in the trap (surrounding the beads). Continued rotary motion of the magnets causes beads to move back and forth in a limited region of the tube around 40, improving elution in a small fluid volume. After elution, resumption of fluid flow delivers this fluid element to the analytical system with little mixing or dilution (a positive feature of capillary tubing systems).

The loop of tubing used as a bead trap in this embodiment can also serve without modification as the sample injection loop of a conventional autosampler sample injection system. The use of the bead trap is thus optional, and its use can be freely interleaved with analytical protocols that do not use magnetic beads.

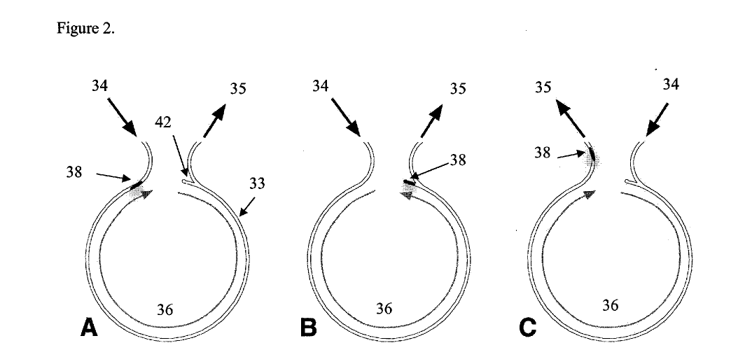

In a second embodiment, shown in FIG. 2, the fluid flow channel has at least one side chamber in fluid communication with the channel but not directly in its flow path (like an ‘appendix’), into which beads can be directed by magnet carrier rotation but within which the beads are shielded from direct exposure to the flowing liquid stream.

In this embodiment, magnetic beads are stably trapped for processing as in the first embodiment (FIG. 2A) when clockwise magnet carrier rotation 36 moves beads 38 against the direction of fluid flow 34 (in this figure the magnets and magnet carrier are not shown, but lie beneath the plane of fluid channel 33, which is a fluid flow region, with which the circle of trap regions is aligned). Side chamber 42, here a non-fluid flow region, is initially empty, and fluid filled, but not on the direct path of fluid flow from inlet 34 to outlet 35. However when the direction of rotation 36 is reversed (now counter-clockwise), beads 38 are transported into side chamber 42 where they remain, out of the fluid flow path. With the beads in this configuration, the flow path between 34 and 35 can be washed to remove any analyte or contaminant that may remain adsorbed to the walls of flow channel 33. Such a cleaning step can be valuable when analyzing very small quantities of an analyte, and any competing, or background, signal is to be minimized in order to improve detection limits (e.g., in mass spectrometry). After this wash, the direction of carrier rotation can be once again reversed, and the beads placed in position for elution (same configuration as FIG. 2A). The beads can be ejected (FIG. 2C) by reversing the direction of liquid flow, so that the beads are ejected out of the trap with outflow 35. A variety of alternate configurations can be devised to achieve the objective of ‘parking’ the beads out of the liquid flow path while the path is washed. In one of these, the side chamber 42 is provided with an independent fluid outlet with a controllable occlusive valve to allow for initial filling of the side chamber with liquid. In general, beads will be ‘parked’ in the side chamber after they are separated from sample in which they have been incubated and washed to remove non-specifically bound materials: the flow channel walls may the have substantial adsorbed material which could be eluted with the beads' specifically bound analytes. Hence the parking of the beads while the flow channel walls are washed provides a means to eliminate this source of analytical contamination.

This embodiment is efficiently realized using a channel (instead of a conventional tube), which can be of non-uniform width, etched in the surface of a planar material that is laminated with a second layer to make a closed lumen, and that has through-holes serving as inlets and outlets. In this case the planar sandwich is the member and the channel is the lumen. Such a configuration can be made using glass or plastic planar materials, and the lamination can be achieved by fusing or cementing glass sheets, or by solvent bonding, gluing or ultrasonically welding plastic sheets. Channels can be created in the surface of a glass plate by chemical etching or sandblasting, and in plastic by molding, machining, chemical etching or photolithography. Clear materials are advantageous since they allow visual observation of the magnetic beads. The cross section of the channel can be square, rectangular, circular, or of arbitrary shape, and of any suitable cross sectional area to provide efficient trapping and stirring of the required volume of magnetic beads (preferably a cross-section equivalent to that of a tube with inside diameter of 50-300 microns).

Creation of the trap channel in a planar substrate offers the opportunity to create more complex channel shapes. If, for example, the “circular” part of the channel is made to deviate slightly inside and outside of the ideal circular profile followed by the magnetic trap regions (i.e., a serpentine path close to the circular profile), the stirring effect exerted on beads being dragged along the channel by magnetic and fluid flow forces can be increased.

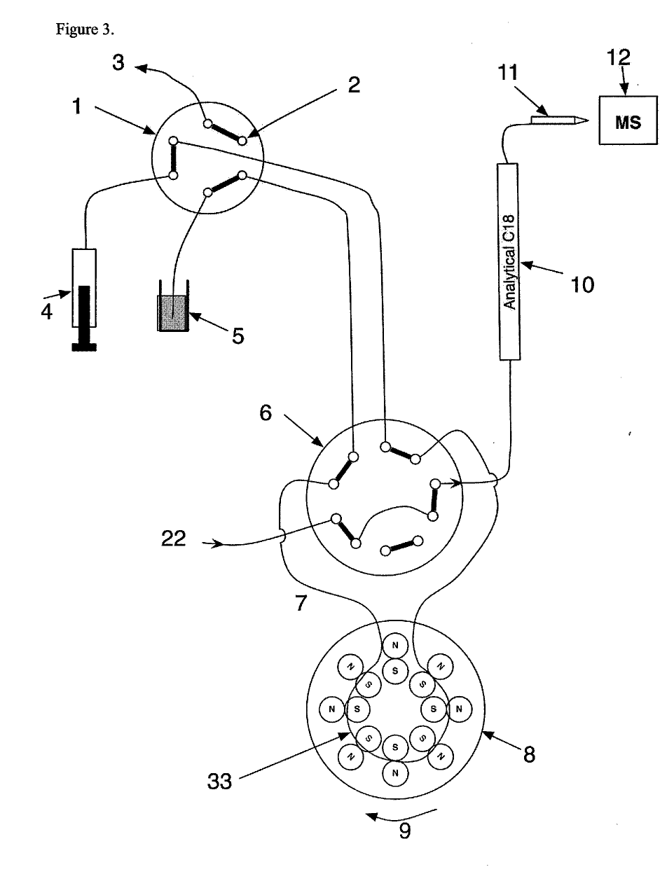

In a third embodiment, shown in FIG. 3, the magnetic bead trap of the first embodiment is integrated into a conventional LC system coupled to a mass spectrometer. In this approach the magnetic beads in suspension are aspirated by suction from syringe 4 from a sample vessel 5 through connecting tubing 7 into a section of tubing 33 held in proximity to a rotating magnet carrier 8 rotating clockwise 9. The sample vessel, which may be a well in a multiwell plate or a vial, may be subjected to a cyclic stirring or shaking motion in order to maintain the beads in suspension. Alternately, the fluid in the sample vessel may be rapidly aspirated and then returned to the vessel several times by syringe 4 to resuspend any settled beads immediately before the final aspiration into the trap, or smaller (e.g. 1 micron dia) beads can be used that do not settle out of suspension quickly. In many cases it can be useful to return the sample minus beads to the sample vessel (or another empty vessel) for subsequent capture or analysis of other analytes. The magnetic field gradients in the bead trap are sufficiently strong to prevent the beads moving out of the trap under the influence of the aspirating fluid flow. Valve 1 can be the 6-port injection valve of a typical autosampler (e.g., LC Packings FAMOS), while a second 10-port valve 6 switches the flow path across the magnetic bead trap (both valves being under control of a computer). For Dynal 2.8 micron beads, a 150-micron internal diameter (ID) capillary tube and a rare earth (e.g., NdFeB) permanent magnet, such a trap can arrest movement of the beads at a flow rate in excess of 1 microliter/min. Following aspiration of a bead suspension into the trap, additional liquid (without beads) can be aspirated from a separate reagent vial to rinse out any beads remaining in the passages of valves 1 and 6 or in connecting tube 7.

Once the beads are loaded into the trap region 33, valve 1 can be switched to connect buffer source 2 to trap capillary 33, permitting the flow of wash buffer over the trapped beads and thereafter to waste 3. Following sufficient washing, valve 6 can be switched to place the bead trap 33 inline with LC solvent source 22 (typically a gradient generator) and a reversed phase separation column 10 (whose outlet is connected via an electrospray interface 11 to a suitable mass spectrometer 12. The leading edge of the gradient, comprising e.g., 0.1% formic acid and 6.7% acetonitrile, can serve to dissociate the bound peptides from the antibodies and elute them onto the reversed phase column prior to reversed phase elution into mass spectrometer 12 (e.g., an Applied Biosystems 4000 QTRAP). These steps can be implemented using a conventional LC system with autosampler (e.g., Spark Holland autosampler with Eksigent LC system), and controlled through the LC system and MS software by use of the software's logic outputs. One such output is used to control the direction of rotation of the bead trap rotor (magnet carrier) to retain or eject beads from the trap, and a second output may be used to turn the rotor motor on and off.

Returning to the flowpath shown in FIG. 3, but with valve 1 in the opposite position and the direction of rotation of magnetic carrier 8 reversed, the flow of wash buffer from pump 2 then expels the beads from the trap region and directs them to waste 3. This process of four steps is repeated for each sample of beads to be removed from a sample digest.

While for simplicity, this embodiment is described as making use of a conventional high pressure LC system, the only high pressure requirement is in the LC solvent source 22, which provides the gradient to resolve analytes over the analytical column 10. Fluid flow over the bead trap generates very little backpressure, and thus buffer source 2 can be either a low pressure or high pressure pump system. The bead trap tube 33 and connecting tubing 7 should be capable of withstanding the pressure applied to analytical column 10 by LC solvent source 22, typically up to 2,000 psig.

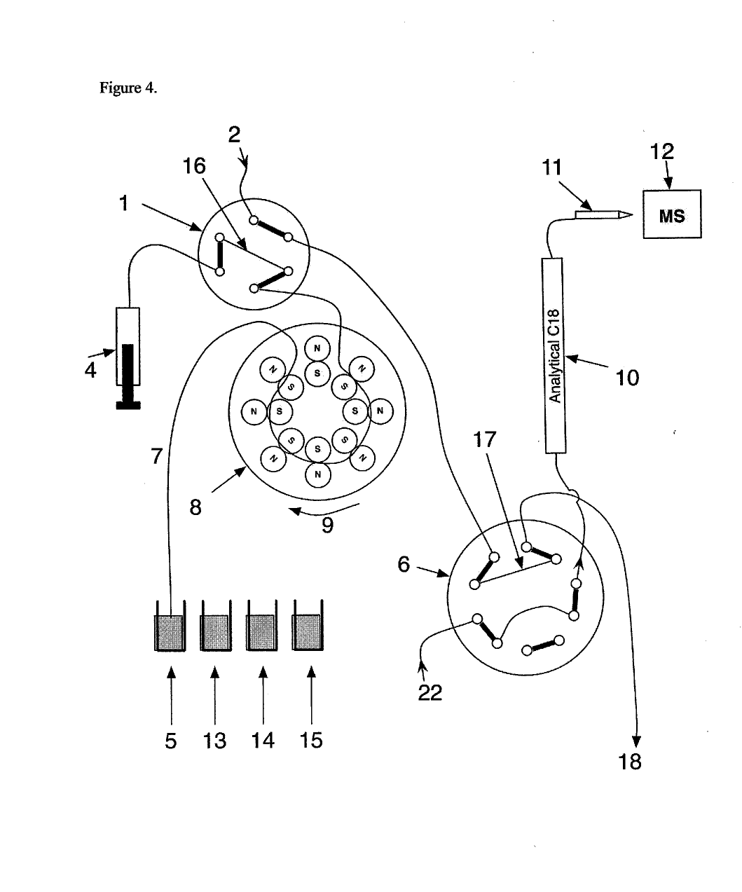

In a fourth embodiment, shown in FIG. 4, a rotating magnetic bead trap is placed in the sample pickup line of a conventional autosampler. In this configuration, it is not necessary to aspirate the magnetic beads through a switchable valve as in the third embodiment. Beads can be aspirated into the bead trap from vessel 5 by action of syringe 4, and afterwards an autosampler used to aspirate wash solution from vessel 13 over the beads retained in the trap. Finally an eluent 14 is aspirated over the beads, and the fluid zone of eluted analytes drawn into transfer loop 16 by careful control of the aspirated volume. Since the eluted analytes are typically obtained in 1-2 ul of eluent, this can easily be located without loss in a 5 microliter transfer loop 16. Valve 1 is then switched to deliver the analyte fluid segment onto reversed phase trap cartridge 17, driven by solvent source 2. Finally valve 6 is switched to place the analyte-containing trap cartridge 17 inline with LC gradient source 22 and analytical column 10, for resolution of analytes by reversed phase separation and delivery to mass spectrometer 12. Beads are ejected from the trap by returning valve 1 to the position shown, reversing the direction of rotation of the magnet carrier 6 and expelling beads into waste 15 by dispensing from syringe 4.

For high-throughput operation, analytical column 10 can be dispensed with, and very short (e.g., 2-5 minute) elution gradients used to deliver analytes from trap 17 directly to spray tip 11 and thus into mass spectrometer 12. Since the magnetic bead trap in this embodiment is placed in a branch of the fluid system that does not require high pressure, materials and fabrication techniques with limited pressure tolerance (such as PDMS soft lithography) can be used.

In a fifth embodiment, a parallel multichannel system is implemented allowing multiple sets of beads to be handled at once, resulting in a high-throughput capability to process samples. In parallel mode the system can employ microfluidics and multiple magnetic bead traps to create 8, 12, or 96 bead traps in a planar or cylindrical configuration, and includes microfluidic switching valves to connect the bead traps with aspiration probes inserted into the sample wells (from which beads binding target analytes at equilibrium are aspirated). In this embodiment, each bead trap channel is a separate lumen, and each can be defined in a separate member or multiple lumens can be defined in one member. In one approach, each bead trap consists of a circular arc of capillary tubing (the tube member defining the lumen) aligned near the surface of a cylinder having a series of linear permanent magnets embedded in its surface, whose long linear dimensions are parallel with the cylinder's axis, forming axial surface stripes on the cylinder. As the cylinder rotates about its axis, the magnets move beneath the capillary tubes, sweeping the beads against liquid flow as required for trapping action. The required number of capillary tubing arcs are placed parallel to one another, spaced apart by 1-5 mm. Alternatively the bead trap fluid paths can be formed as a series of parallel straight channels (here the multiple lumens) in a flexible laminate (here one member), which is then curved around the cylinder so that each of the channels follows a circumference of the cylinder. Once aspirated from respective wells into respective traps, the beads in each trap can optionally be washed by microfluidic connection of the traps to a source of wash buffer (input) and waste (output).

For elution, the device is set to serial mode, such that a first bead trap is connected at one end to a source of eluent (which may also be the leading edge of a reverse-phase chromatography elution gradient) and a the other end to a common output channel leading to the analytical instrument (frequently a mass spectrometer, or alternatively a reverse-phase trap or chromatography column implementing a separation of analytes before introduction into the MS). Once the analysis of the analytes eluted from the first bead trap is complete and the analytical system is recycled, a second bead trap is switched using microfluidic valves into connection with the eluent source and analytical system (replacing the first bead trap), and the process repeated. After this, the third bead trap is similarly unloaded and so on until all the bead traps are unloaded and analyzed. Following this process, the bead traps can be unloaded by reversing direction of the cylinder rotation and pumping liquid through all the traps. Depending on the binding agents carried by the beads in the different traps, they can be ejected into a single output reservoir (e.g., if all the bead sets carry the same binding agents to capture the same analytes from all the samples), or they can be switched so as to be unloaded serially into different output reservoirs (e.g., if each set of beads carries different binding agents). If the beads are not to be re-used, then all traps can be unloaded into a single waste reservoir (either serially or in parallel). In a related implementation, the multichannel bead trap is mated with a multichannel reversed phase LC system to permit more efficient utilization of the MS. In this case, the MS is connected to one LC system while another is being recycled and loaded with analyte from a bead trap.

The microfluidic valve system implementing this embodiment can be made using any of a range of technologies, including soft polymer lithography, that provides the ability to address individual bead traps and connect them selectively to input and output fluid lines. It is highly desirable to select materials for the microfluidic system that do not bind the analytes being studied, and also do not leak chemicals into the fluid streams that could impact the analytical performance of the MS detectors.

When it proves difficult to arrange the valve system so as to be able to operate in both parallel (for loading the traps) and serial (for eluting into the analytical system) modes, it is possible, though more time-consuming, to load the traps serially, by pulling bead suspension from one well at a time as each trap is successively connected with a probe that moves from well to well.

In a sixth embodiment, extra care is taken to ensure delivery of analytes eluted from magnetic beads into a chromatographic system. In this embodiment, analytes are eluted from magnetic beads (in a rotary bead trap as described in the first embodiment) in a solvent such as 50% acetonitrile/0.1% formic acid, which effectively prevents their binding to other surfaces (tubing walls etc.) This elution approach minimizes loss of analyte during transport from the bead trap region to the analytical system. Typically, however, this approach also decreases binding of the analytes to resolving components of the LC analytical system itself (e.g., C18 reversed phase). In order to allow resolution of analytes on C18 traps and columns, in this embodiment the eluate from the beads is diluted with aqueous solvent to reduce the organic content to a level allowing analytes to bind to C18 and similar materials (e.g., 5-10% acetonitrile). In practice this can be achieved by combining the eluate from the bead trap with a diluent flow (e.g., 9-fold higher flowrate of 0.1% formic acid) in a nano-mixer to yield a solution of analytes in <5% acetonitrile/0.1% formic acid. This solution is immediately delivered to a reversed phase trap cartridge, from which it is delivered into the reversed phase analytical system prior to MS analysis. The diluent flow is provided by an additional diluent pump. The analyte is thus eluted from the magnetic beads and delivered to the mixer in a high-organic solvent that effectively prevents any binding to the walls of tubing; only at a point immediately before delivery onto a C18 trap cartridge or analytical column is the analyte diluted in a mixer to a level of organic that permits binding to the C18 material.

In an seventh embodiment, the magnetic bead trap is integrated using microfluidic approaches with necessary valves, mixer, C18 trap and analytical column in a unified, miniaturized, generally planar analytical system with minimum volume and surface area. These components can be implemented using any of a variety of technologies based on lamination of various glass or plastic materials. An attractive embodiment uses DuPont Kapton polyimide plastic film, in which the required channels can be ablated on the surface of one sheet with a laser and multiple layers (some with through holes) bonded together using well-established technologies (Barrett, Faucon, Lopez, Cristobal, Destremaut, Dodge, Guillot, Laval, Masselon and Salmon, Lab Chip 6:494-499, 2006; U.S. Pat. No. 6,958,119 “Mobile phase gradient generation microfluidic device”). The combination of a magnetic bead trap with multiport valves, C18 traps and columns, and a nano spray tip to deliver analytes into a mass spectrometer provides an integrated manufacturable solution for analyte handling, while minimizing the system's total volume and surface area (thus decreasing adsorptive losses), and the potential for leaks. This embodiment also allows the bead trap and other components to be miniaturized effectively, thus allowing very small amounts of beads to be used. Since conventional Dynal magnetic beads can bind large amounts of analyte in relation to mass spectrometric detection limits (for example 5 picoliters of packed Dynal protein G beads can bind antibody with a total of 1500 fmol binding sites), there is a substantial advantage in miniaturizing the bead trap and other plumbing to handle these very small volumes of beads.

In an eighth embodiment, a novel magnetic particle is used to deliver analytes to a magnetic bead trap. While magnetic beads coated with proteins or peptides are usually sufficiently “non-sticky” to allow delivery through conventional silica or Teflon tubing and subsequent handling in magnetic bead traps made of these materials, very hydrophobic beads, such as those coated with C18 coatings, are so sticky that they are very difficult to transport. Use of high concentrations of detergents to overcome this stickiness is counterproductive since it would interfere with analyte binding to the beads. In order to overcome this difficulty, novel magnetic beads can be used having the following hybrid structure: a porous hydrophobic interior containing magnetic material, and a hydrophilic porous exterior that permits passage of hydrophobic molecules in a wide variety of solvents but which does not adhere to the walls of silica or Teflon tubing.

Non-magnetic beads with different internal and external characteristics are known as “restricted access media” (RAM) supports. RAM support particles have an interior modified with e.g., C18 to which low molecular weight analytes (e.g., peptides) can bind, and an exterior coating, which is hydrophilic and excludes large molecules from the particle interior. In this embodiment, the analyte-binding properties of the magnetic beads are independent of the surface properties, which can be optimized to prevent sticking of the beads to the walls of vessels, tubing or to other beads. In a particularly useful embodiment, the beads have an external surface that is hydrophilic and does not stick to glass, silica, metal or plastic (PEEK, Teflon, Kapton) surfaces employed in the flowpath. Inside this surface, the magnetic bead has a phase optimized to bind a class of analytes. For example, in a particularly useful case the bead interior (which is accessible to analyte molecules in the surrounding solution) is modified with C18 groups capable of binding a wide variety of chemical and biological analytes by hydrophobic interaction. These particles are thus characterized by having different inner and outer phases, the outer phase being selected to prevent binding of the beads to materials of a fluid transport system, and can be termed “slippery-surface” or “SS” beads. Whereas conventional Dynal beads having an exterior coated with C18 are sticky, clump with one another in aqueous solvents, and bind to exposed surfaces (e.g., of tubing), the 2-phase SS beads bind analyte in their interior but do not bind to surfaces because of their non-hydrophobic exterior. A third component of the beads is a magnetic material such as iron oxide, rendering the beads susceptible to a magnetic field. Using these magnetic beads, a very wide variety of analytes can be sequestered or enriched from a sample (by binding to the bead's C18 interior), transported without loss to a magnetic bead trap as described here, and eluted in a minimal volume for subsequent analysis (e.g., by mass spectrometry). Captured analytes can be stored for long periods on SS beads without appreciable loss, ready for analysis without further processing. The use of SS beads thus overcomes a major problem in analyte handling common to many environmental, pharmaceutical, forensic and biological research applications.

In any of the above embodiments, the sample can be preserved if needed after capture of one set of analytes on magnetic beads. When used in the context of the SISCAPA method, a set of beads carrying binding agents specific for a first set of monitor peptides would be added to the sample well and incubated. Then these beads would be collected (removed from the sample well) as described in the present embodiment, transported by the flow system to a bead trap, and the bound peptides eluted for MS analysis. The peptides remaining in the sample well are maintained in a condition suitable for another round of capture with a second set of beads, or for other analyses.

### EXAMPLES

In a first example, a magnetic bead trap was constructed using ¼″ dia× 3/16″ thick cylindrical NdFeB magnets (Amazing Magnets, Inc.), pairs of which were held by epoxy glue on the end face of a cylindrical aluminum magnet carrier, which in turn was rotated about its cylinder axis by a reversible motor (a 2 RPM Oriental Motor SMK216A-GN/2GN30KA Low-Speed Synchronous Motor). The magnet faces were arranged to be approximately co-planar on their upper surface. Direction of motor rotation was controlled by an AC relay, which was in turn was controlled by a solid-state relay controlled by either a contact closure signal from a Spark Holland autosampler auxiliary output under software control, or else by a manual toggle switch. A length of 150 u ID (360 u OD) Teflon capillary tubing (Upchurch Scientific) was configured to follow approximately 240 degrees of a circle of diameter the same as (and co-axial with) the circle of trapping regions (i.e., the circle defined by the contact points of the pairs of magnets as they rotate: FIGS. 1 and 3). This tube was affixed (in the appropriate partial circular path) by a piece of thin clear adhesive tape on the underside of a tubing mount plate of clear acrylic plastic, which was finally brought parallel to the upper face of the magnets on the carrier disk and close to them so as to almost touch the upper surface of the magnets on the magnet carrier disk and aligned so that the tube followed the path of the trap regions as the carrier rotated underneath. Alignment of the tubing mount plate parallel to and close to (but not touching) the upper face of the magnet carrier was facilitated by the use of four threaded rods with fingernuts used to force the tubing mount plate towards the magnet carrier upper surface against the resistance of four springs. The fingernuts were tightened until a thin sheet of paper could barely be inserted between the magnets and the capillary tubing at any point.

In an initial test, one end (the “upstream” end) of the tube was connected to a 6-port chromatography injection valve, to allow controllable connection to either 1) a source of flowing liquid (in this case from a programmable syringe pump) or 2) an injection loop loaded with beads or solvent. In this configuration it was determined that a mass of beads equivalent to 1-5 ul of Dynal 2.8 u Dynabeads (at stock concentration from the manufacturer's bottle; equal to about 40-200 nl packed bead volume) could be trapped reliably against a flow of up to 10-20 ul/min through the 150 u ID tube. In the presence of 0.1-1.0% octylglucoside detergent, these beads were vigorously stirred by the passage of each trapping region (during magnet carrier rotation) but were kept near the first trap (where the fluid flow enters the circular part of the tube, equivalent to location 40 in FIG. 1). When aqueous solvents without detergent were flowed over the trapped beads, the beads gradually began to adhere to the Teflon walls of the tube and form a light brown coating (the beads themselves are brown due to iron oxide content) over ˜100 degrees arc of the curved tube (beginning at the first trap region and extending downstream), while the remaining majority of the beads remained as a stirred mass in the first trap region. This mass showed more evidence of clumping, and did not flow so smoothly, as beads in the presence of detergent, but nevertheless remained trapped and mixing with the liquid flow. This is important, since while beads may be loaded into the trap in the presence of some detergent, in generally it may be desirable to wash the beads and elute the bound analyte in the absence of detergent (which can in some cases interfere with subsequent MS analysis). At the end of the process, when it is desirable to eject the beads from the trap, an injection of a small volume (e.g., 1 ul) of 1% octylglucoside or CHAPS detergent caused the beads to immediately release from the tubing walls and form a smoothly flowing mass. Solvents with appreciable organic content (e.g., 25% acetonitrile in water) also prevented bead binding to the tubing walls. When the direction of trap carrier rotation was then reversed, the bead mass was smoothly transported out of the trap and ejected through the exit tube. No visible beads remained in the tubing of the trap. This experiment demonstrated a practical bead trap using economical components, and compatible with a loop of any type of capillary tubing (or any channel created in a planar microfluidic structure) that follows the rotation of the trap regions.

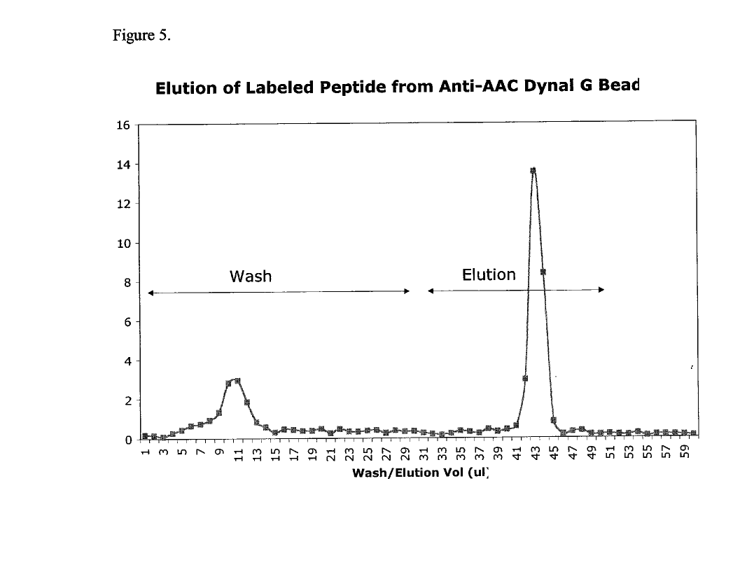

Elution of fluorescently labeled analytes from magnetic beads in the bead trap could be followed to determine the efficiency of elution. In this case Dynal 2.8 micron beads coated with protein G were reacted with rabbit polyclonal antibody to a peptide of human alpha-1-antichymotrypsin (AAC), and subsequently reacted with a fluorescein-labeled version of the same peptide, creating a bead-protein G-antibody-peptide sandwich. These beads were aspirated into a rotary magnetic bead trap as described in the first embodiment, and then a wash solution was flowed through the bead trap, bathing the beads. After complete washing (here 30 microliters of phosphate buffered saline), an eluent consisting of 5% acetic acid was flowed through the trap over the beads. During the washing and elution, 1 microliter fractions of the outflow from the magnetic bead trap was collected, brought to neutral pH, and subsequently assayed for fluorescence using a fluorescence plate reader set up to detect fluorescein. FIG. 5 shows the results, which demonstrate a very sharp elution of bound fluorescent peptide (peak at 43 ul) approximately 12 ul after eluent flow was started (12 ul being the tubing delay from input to out of this trap). The width of this peak at half-height is ˜2 microliter, and would likely appear even narrower if smaller fractions had been collected. This demonstrates that the peptide analyte elution from magnetic beads occurs quickly and effectively in the bead trap, resulting in a small volume of eluent.

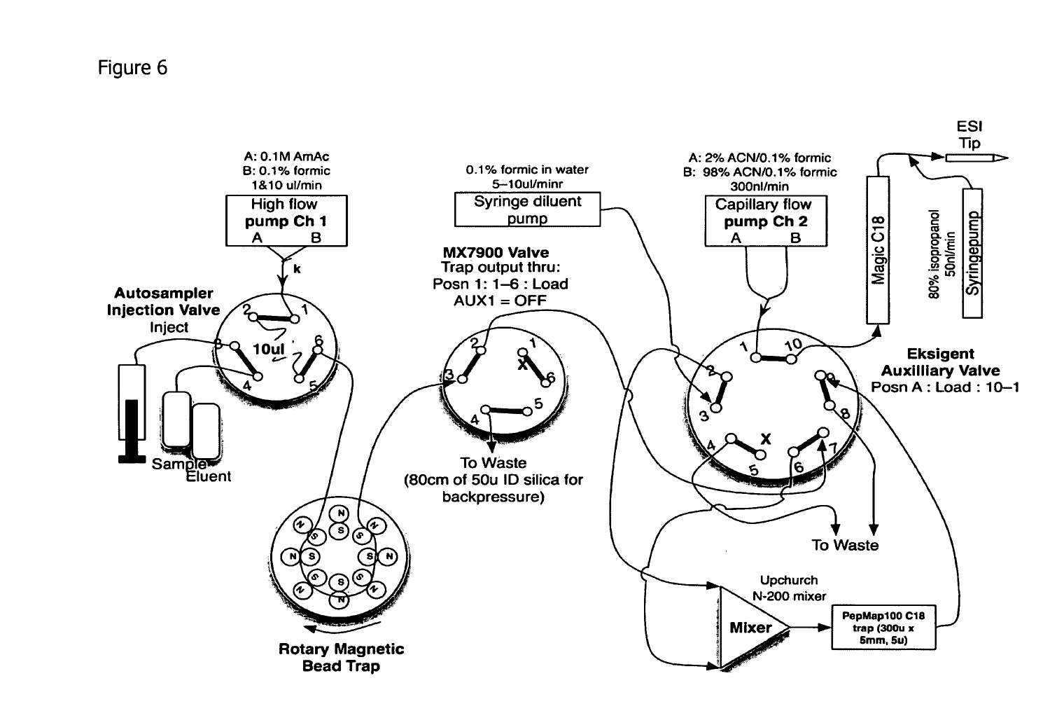

In a second example, a SISCAPA experiment (Anderson, Anderson, Haines, Hardie, Olafson and Pearson, J Proteome Res 3:235-44, 2004) was carried out using the same rotary bead trap device integrated into a conventional nano-flow LC system (Spark-Holland Famos autosampler with Eksigent 2D pump system) coupled with an Applied Biosystems 4000TRAP mass spectrometer (plumbing setup shown in FIG. 6).

Dynal protein G Dynabeads (5 ul at original concentration) were used after loading with 1 microgram of rabbit polyclonal antibody to a peptide of human alpha-1-antichymotrypsin (Anderson, Anderson, Haines, Hardie, Olafson and Pearson, J Proteome Res 3:235-44, 2004). These beads were incubated with a tryptic digest of 160 nanoliter of human plasma proteins, and 10 microliters of the beads plus digest aspirated by the autosampler and pumped into the bead trap.

In this case, the bead trap device (whose flowpath consisted of 150 micron ID Teflon tubing having 8 microliter volume) was placed between the autosampler injection valve and an additional switching valve (MX7900). The MX7900 valve directed the outflow from the bead trap either to waste (during trap loading and bead washing) or to a 10-port auxiliary valve and thence to a PepMap C18 trap cartridge (during analyte elution). Loading, washing and elution of the bead trap were all carried out by injection of 10 microliter volumes of the appropriate solutions from reagent vials on the autosampler, driven by 1 microliter/min flow of buffer from a high flow pump. During analyte elution from the bead trap (by injection of 10 microliter of 70% acetonitrile/0.1% TFA), the eluate was combined with a flow of 10 microliter/min of 0.1% formic acid in an Upchurch N-200 nanomixer to yield an analyte solution in 6.7% acetonitrile that was directed onto the C18 trap. After washing, the Eksigent auxiliary valve was switched to place the trap inline with a 15 cm×75 micron C18 analytical column driven by a 300 nanoliter/min gradient of 2% to 98% acetonitrile in 0.1% formic acid lasting ˜30 min. Beads were finally ejected completely by injection of a volume of 1% CHAPS detergent while reversing the direction of bead trap magnetic carrier rotation (so as to be in the same sense as the liquid flow) and directing the eluent to waste. The eluent of the C18 analytical column was supplemented with 50 nanoliter/min of 80% isopropanol to improve constancy of the nanospray entering the MS. The mass spectrometer was used in triple quadrupole mode to quantitate 57 selected reaction monitoring (SRM) transitions previously shown to be specific for 57 peptides representing 57 proteins in human plasma (Anderson and Hunter, Mol Cell Proteomics 5: 573-588, 2006). The apparatus was controlled through Applied Biosystems Analyst software and Eksigent LC software, including the bead trap rotation and on-off signals.

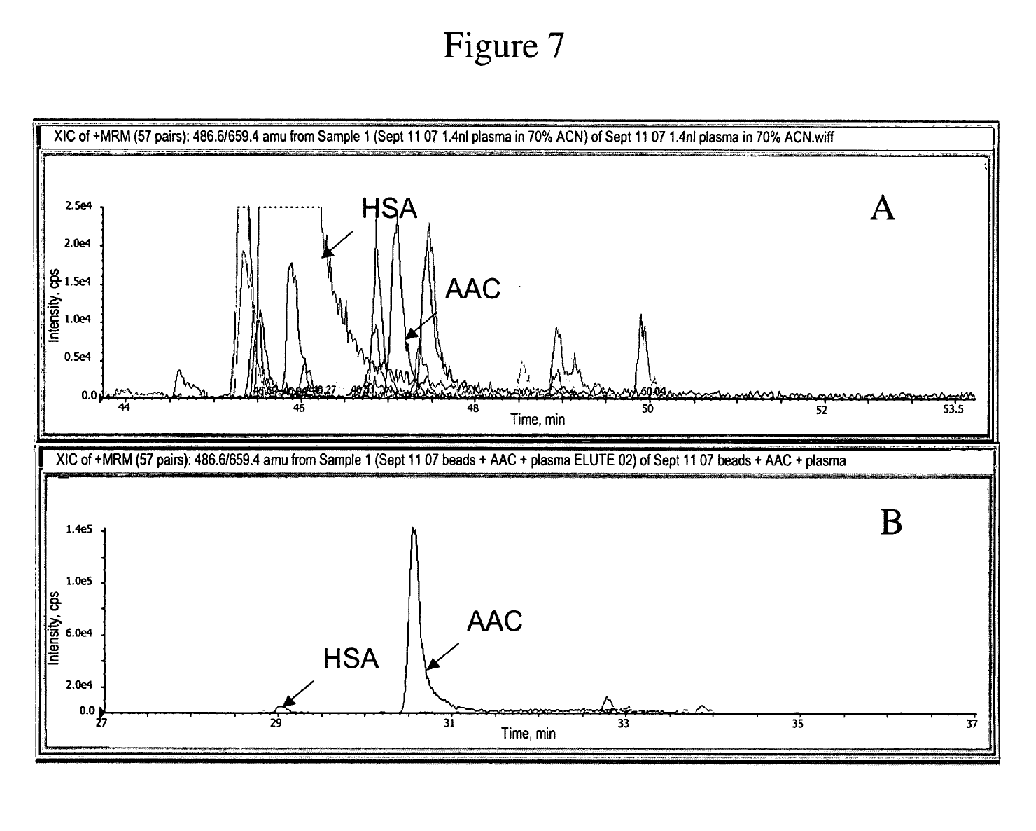

The pattern of 57 specifically detected peptide peaks from an analysis of an unfractionated human plasma digest under similar run conditions (same LC gradient) is shown in FIG. 7A. The timescale is retention time on the analytical C18 column, and each peptide monitored elutes as a distinct peak, while different peptides show widely differing peak heights (indicative of differing amounts, as expected due to the widely differing concentrations of these proteins in plasma). FIG. 7B shows the peak pattern of the eluate from the bead trap in a SISCAPA capture experiment in which the antibody to a peptide of human alpha-1-antichymotrypsin has bound that peptide (peptide peak labeled AAC) from a digest of human plasma, and the other 56 peptides monitored (which should not be bound by the antibody) have been substantially washed away in the bead trap. The same 57 peptides are monitored in both runs. The anti-peptide antibody on the magnetic beads has clearly retained the specific peptide for which it was designed while all other peaks including the extremely abundant human serum albumin peptide (labeled HSA) are very substantially diminished in the SISCAPA experiment compared to the unfractionated plasma digest of FIG. 7A. The ratio between the peak areas of AAC (target analyte) peptide and HSA (non-target) peptide was increased by 1.800-fold (the enrichment factor) as a result of SISCAPA enrichment and processing in the bead trap. This demonstrated the ability of the magnetic bead trap to effectively carry out a specific capture/elution process on magnetic beads under control of a computerized LC-MS/MS system.

1. An apparatus, comprising:
a member defining a lumen, the lumen being configured to convey fluid;
a first magnetic field generator configured to move with respect to the member from a first position to a second position different from the first position, the magnetic field generator being configured to apply a magnetic field gradient to a first portion of the lumen when the magnetic field generator is disposed at its first position, the magnetic field generator being configured to apply a magnetic field gradient to a second portion of the lumen when the magnetic field generator is disposed at its second position, the first portion of the lumen being different from the second portion of the lumen; and
a second magnetic field generator configured to move with respect to the member from a first position to a second position different from the first position, the second magnetic field generator being configured to apply a magnetic field gradient to the first portion of the lumen when the second magnetic field generator is disposed at its first position, the second magnetic field generator being configured to apply a magnetic field gradient to the second portion of the lumen when the magnetic field generator is disposed at its second position.

2. The apparatus of claim 1, wherein the first magnetic field generator is spaced from the second magnetic field generator, the magnetic field generators being configured to move from the first positions to the second positions along a first path configured to apply a magnetic field gradient to the segment of lumen connecting the first and second portions of the lumen, the magnetic field generators being configured to move from the second positions to the first positions along a second path different from the first path.

3. The apparatus of claim 1, further comprising:
a fluid flow control mechanism being configured to selectively cause fluid to flow within the lumen either from the first portion of the lumen to the second portion of the lumen or from the second portion to the first portion.

4. The apparatus of claim 1, further comprising:
a direction control mechanism being configured to selectively cause the magnetic field generators to move along the path of claim 1, or along the same path in a reverse direction.

5. The apparatus of claim 1, wherein the magnetic field generator is a permanent magnet.

6. The apparatus of claim 1, wherein the magnetic field generator is an electromagnet.

7. The apparatus of claim 1, wherein the first magnetic field generator is coupled to a rotor and is configured to move in a circle.

8. The apparatus of claim 1, wherein the member is configured to be connected to an analytical device such that the lumen is in fluid communication with the analytical device.

9. The apparatus of claim 1, wherein the first magnetic field generator is configured to move magnetic beads disposed within the lumen from the first portion of the member to the second portion of the member when the magnetic field generator moves from its first position to its second position and while fluid is being conveyed by the lumen.

10. The apparatus of claim 9, further comprising:
a sensor configured to detect when the magnetic beads are located at the second portion of the member.

11. The apparatus of claim 1, the member being a first member, the lumen being a first lumen, further comprising:
a second member defining a second lumen, the second lumen being configured to convey fluid,
the first magnetic field generator being configured to apply a magnetic field gradient to a first portion of the second lumen when the magnetic field generator is disposed at its first position, the magnetic field generator being configured to apply a magnetic field gradient to a second portion of the second lumen when the magnetic field generator is disposed at its second position, the first portion of the second lumen being different from the second portion of the second lumen.

12. The apparatus of claim 1, wherein the lumen includes a first end portion and a second end portion, the first end portion being configured to be selectively coupled to either a first input or a second input, the second end portion being configured to be selectively coupled to either a first output or a second output.

13. The apparatus of claim 1, wherein the lumen includes a fluid flow region and a non-fluid flow region, the first portion of the lumen being located in the fluid flow region of the lumen, the second portion of the lumen being located in the non-fluid flow region of the lumen.

14. An apparatus, comprising:
a member having a first end portion and a second end portion, the member defining a lumen extending from the first end portion of the member to the second end portion of the member, the lumen being configured to convey fluid; and
a carrier configured to move from a first position with respect to the member to a second position with respect to the member along a first path, the carrier being configured to move from the second position to the first position along a second path different than the first path;
a first magnetic field generator coupled to the carrier at a first site on the carrier; and
a second magnetic field generator coupled to the carrier at a second site on the carrier, the second site on the carrier being different from the first site on the carrier,
the member being disposed proximate the carrier such that
when the carrier is at its first position the first magnetic field generator is configured to apply a magnetic field gradient to the lumen at a first location and the second magnetic field generator is configured to apply a magnetic field gradient to the lumen at a second location, the first location being different from the second location, and
when the carrier is at its second position the first magnetic field generator is configured to apply a magnetic field gradient to the lumen at the second location and the second magnetic field generator is configured to apply a magnetic field gradient to the lumen at a third location, the third location being different from the first location and the second location.

15. The apparatus of claim 14, further comprising:
a fluid flow control mechanism operatively coupled to the member, the fluid flow control mechanism being configured to selectively cause fluid to flow within the lumen from either the first end portion of the member to the second end portion of the member or from the second end portion of the member to the first end portion of the member.

16. The apparatus of claim 15, wherein the carrier is configured to selectively move either in a first direction or in a second direction different from the first direction.

17. The apparatus of claim 14, wherein the lumen has a diameter of between 50 and 300 microns.

18. The apparatus of claim 14, wherein the member is made of at least one of fused silica, Teflon, polyetheretherketone, Kapton, polydimethylsiloxane, and polyethylene.

19. The apparatus of claim 14, wherein the member is configured to be connected to an analytical device such that the lumen is in fluid communication with the analytical device.

20. The apparatus of claim 14, wherein the lumen is configured to convey magnetic beads.

21. The apparatus of claim 14, the member being a first member, the lumen being a second lumen, further comprising:
a second member having a first end portion and a second end portion, the second member defining a lumen extending from the first end portion of the second lumen to the second end portion of the second lumen, the second lumen being configured to convey fluid,
the second member being disposed proximate the carrier such that
when the carrier is at its first position the first magnetic field generator is configured to apply a magnetic field gradient to the second lumen at a first location and the second magnetic field generator is configured to apply a magnetic field gradient to the second lumen at a second location, the first location being different from the second location, and
when the carrier is at its second position the first magnetic field generator is configured to apply a magnetic field gradient to the second lumen at the second location and the second magnetic field generator is configured to apply a magnetic field gradient to the second lumen at a third location, the third location being different from the first location and the second location.

22. The apparatus of claim 14, wherein the carrier is a rotor and is configured to rotate about an axis from the first position to the second position.

23. The apparatus of claim 22, the lumen having a middle portion disposed between the first end portion and the second end portion, the middle portion forming a arc of a circle about the axis.

24. The apparatus of claim 14, wherein the first magnetic field generator is configured to move magnetic beads from the first location of the lumen to the second location of the lumen when the carrier moves from its first position to its second position.

25. The apparatus of claim 14, wherein the first magnetic field generator is a permanent magnet.

26. The apparatus of claim 14, wherein the lumen includes a fluid flow region and a non-fluid flow region, the first location of the member being located in the fluid flow region of the lumen, the second location of the member being located in the non-fluid flow region of the lumen.

27. The apparatus of claim 14, where in the member is a planar laminate incorporating one or more of a switching valve, a chromatographic trap column, a chromatographic analytical column, and an electrospray tip.

28. A method of collecting magnetic beads in a lumen defined by a member, comprising:
introducing a fluid and the magnetic beads into the lumen;
moving a magnetic field generator along a path from a first position adjacent to a first portion of the lumen to the second position adjacent to a second portion of the lumen a path, the magnetic field generator being configured to apply a magnetic field gradient to a third portion of the lumen disposed between the first portion of the lumen and the second portion of the lumen; and
moving the magnetic field generator along a second path different than the first path from the second position to the first position.

29. The method of claim 28, further comprising:
passing a wash liquid through the lumen of the member and past the magnetic beads; and
passing an elution liquid through the lumen of the member and past the magnetic beads to elute an analyte bound to the magnetic beads.

30. The method of claim 29, further comprising:
analyzing the analyte.

31. The method of claim 30, wherein the analyzing includes passing the analyte through a mass spectrometer.
